(19) United States
(12) Patent Application Publication
(10) Pub. No.: US 2009/0274815 A1
(43) Pub. Date: Nov. 5, 2009

(54) RICE MODIFIER, COOKED RICE FOOD USING THE RICE MODIFIER, AND THOSE PREPARATION PROCESSES

(75) Inventors: Isao Kobayashi, Tokyo (JP); Morito Watanabe, Tokyo (JP); Takeshi Suzuki, Tokyo (JP); Masaru Goto, Tokyo (JP)

Correspondence Address: TUROCY & WATSON, LLP, 127 Public Square, 57th Floor, Key Tower, CLEVELAND, OH, 44114, US

(73) Assignee: J-OIL MILLS, INC, Chuo-ku, Tokyo (JP)

(21) Appl. No.: 12/440,981

(22) PCT Filed: Aug. 31, 2007
(86) PCT No.: PCT/JP2007/000943

§ 371 Date: Mar. 12, 2009

(30) Foreign Application Priority Data
Sep. 13, 2006 (JP) 2006-247610

(51) Int. Cl. A23L 1/18; A23L 1/0522; A23P 1/02; A23L 1/00

(52) U.S. Cl. 426/578; 426/518; 426/509; 426/625

(57) ABSTRACT

A rice modifier, containing a granular material sieved over 0.5 mm-opening (32-mesh) sieve at a content of 5% by weight or more and 100% by weight of less, having thermal solubility of equal to or higher than 20%, and containing starch at a content of equal to or larger than 40% by weight.

### TECHNICAL FIELD

The present invention relates to a rice modifier, a cooked rice employing thereof, and a process for preparing thereof.

### RELATED ART

The type of a rice for cook, which satisfies the preference of the Japanese citizens, is the rice represented by Japonica rice, which exhibits appropriate gloss and stickiness. Such gloss and stickiness are mainly resulted from the level of amylopectin content in the rice, and KOSHIHIKARI, SASANISHIKI and the like, containing amylopectin at relatively higher content ratio generally satisfy the taste buds of the Japanese citizens. While such cooked rice provide preferable eating-quality with an appropriate gloss and stickiness right after the cooking is finished, the decrease of the eating-quality is progressed as time passes. This is resulted from an aging of starch contained in the rice, and the decrease of the eating-quality of the cooked rice over time caused in the distribution at a room temperature or under the chilled condition is the phenomenon that is difficult to be avoided. However, the advances of the catering industry and the take-away food industry in recent years highly require maintaining the tastes of the cooked rice for longer term at a room temperature or under the chilled condition after the cooking, and thus technologies for maintaining the tastes of the cooked rice for longer term are required.

Further, interests in the miscellaneous grain crops such as unpolished rice, barley, Japanese millet (“hie”), Italian millet (“awa”), proso millet (“kibi”) and the like are increased in the recent years, on the basis of health-consciousness and/or natural-consciousness related to the foods. The type of the cooked rice containing such miscellaneous grain crops as replacing portions of the rice tends to be mealy as compared with the polished white rice when it gets cold, causing a problem of decreased eating-quality. In addition, another problem of deterioration in the flavor is arisen, due to rice bran-smell and old rice-smell characteristic of the unpolished rice and the old rice, respectively.

On the other hand, waxy starch or glutinous starch represented by the waxy corn starch is a special starch containing amylopectin at the content of 100%. The characteristics thereof is a capability of forming starch glue having higher ageing resistance, higher stickiness and higher transparency, as compared with starch glue of ordinary starch. Besides, modified starch typically including acetylated starch, etherified starch and the like is the starch, which exhibits reduced ageing phenomenon peculiar to the starch, and is broadly utilized for noodles, breads and the like, in order to reduce the deterioration of the foods in the condition of the chilled preservation, as well as in the condition of the preservation at the room temperature.

Number of processes employing such waxy starch, modified starch and/or starch-degraded products for achieving the quality improvement of the cooked rice are reported. Japanese Patent Laid-Open No. 2004-201,617 (Patent Document 1) discloses a report of a rice modifier employing both of a starch degraded product and oligosaccharides. However, while the technology described in the Patent Document provides improved stickiness, further improvement in maintaining the gloss of the cooked rice is required.

Japanese Patent Laid-Open No. H7-264,998 (1995) (Patent Document 2) describes mixed rice additives obtained by etherifying/esterifying at least one of grain flours selected from a group consisting of rice starch, glutinous rice starch, rice flour, glutinous rice flour and rice flour for dumplings.

Japanese Patent Laid-Open No. 2002-65,184 (Patent Document 3) describes a manner for providing improved mechanical characteristics of the cooked rice such as release-ability from a kettle, loose-ability, and the like by adding etherified and/or oxidized modified starch in the cooking.

Further, Japanese Patent Laid-Open No. 2004-121,082 (Patent Document 4) discloses a method for providing improved formability of rice balls by cooking the rice with an additive of cross-linked starch and the like.

All of the technologies described in the above-described Patent Documents 2 to 4 are made, assuming that starch is added shortly before the cooking in the form of powder. However, in the manners of adding such substances, starch precipitates while the rice is immersed in water in the industrial cooking production line, and then the precipitated starch is gelatinized in first in the cooking process to provide an increased viscosity of water used in the boiling rice, leading to an obstruction for uniform heat transfer in the rice for cook. Consequently, the rice located in the upper portion within the rice kettle becomes cooked rice having a core and on the other hand, the rice located in the lower portion in the rice kettle becomes the sticky cooked rice with the rice grains being half-crushed. In addition, considerable amount of so-called “oblate-like layers” are generated in the bottom of the rice kettle, causing a decrease in the cooking production yield, additional handling for cleaning or the like. Thus, the above-described approach of adding starch in a form of powder just after finishing the cooking have not been put into practical use.

Japanese Patent Laid-Open No. S51-44,660 (1976) (Patent Document 5) describes a rice modifier, produced by mixing powder starch syrup, starch, germ, hydrolase and the like and then pressure forming the mixture. Starch syrup is employed as an active constituent of the modifier in such rice modifier. Starch syrup is obtained by degrading starch with acid or enzyme, and small amount of starch is also employed as a binder for pressure forming such starch syrup.

However, since the modifier described in the Patent Document contains powder starch syrup as the major constituent, sufficient effect for modifying the cooked rice cannot be achieved, there are needs to be improved in gloss, stickiness and eating-quality. As described above, the conventional technologies for providing improved quality of the cooked rice employing starch and starch degraded product have not been put into practical use.

[Patent Document 1] Japanese Patent Laid-Open No. 2004-201,617;

[Patent Document 2] Japanese Patent Laid-Open No. H7-264,998 (1995);

[Patent Document 3] Japanese Patent Laid-Open No. 2002-65,184;

[Patent Document 4] Japanese Patent Laid-Open No. 2004-121,082;

[Patent Document 5] Japanese Patent Laid-Open No. S51-44,660 (1976).

### DISCLOSURE OF THE INVENTION

In consideration of the above-described conditions, the present invention is to provide a rice modifier, which maintains and improves the gloss and the stickiness the cooked rice originally has, and also provides an effect for improving eating-quality, eating-texture and flavor.

According to one aspect of the present invention, there is provided a rice modifier, containing a granular material sieved over 0.5 mm-opening (32-mesh) sieve at a content of 5% by weight or more and 100% by weight or less, having thermal solubility of equal to or higher than 20%, and containing a starch at a content of equal to or larger than 40% by weight, and a process for preparing thereof.

According to another aspect of the present invention, there is provided a process for preparing a cooked rice food, including cooking a rice after adding the above-described rice modifier at a ratio of 0.1% by weight or more and 10% by weight or less over the rice, and a cooked rice food cooked by the process for preparing the cooked rice food.

The rice modifier according to the present invention exhibits the content of the components over 0.5 mm-opening (32-mesh) sieve, thermal solubility and starch content, which fall within specific ranges, respectively, so that the modifier is uniformly distributed over the rice for cooking, and then is gradually dissolved in the cooking process. Consequently, gloss and stickiness are uniformly provided for the cooked rice, providing considerably improved eating-quality, an eating-texture and flavor.

The use of the rice modifier according to the present invention achieves uniform dispersion of the rice-modifying constituent, providing the cooked rice food without causing quality decrease in the preservation of the cooked rice.

### BEST MODE FOR CARRYING OUT THE INVENTION

A rice modifier in the present invention is configured to exhibiting content of components over 0.5 mm-opening (32-mesh) sieve, thermal solubility and starch content, which fall within specific ranges, respectively, so that a considerable effect for modifying quality of the cooked rice is achieved. The technical significance of the above-described configuration will be described as follows.

The rice modifier according to the present invention is provided by processing a raw material containing starch into a granular material. The content of the granular particles over 0.5 mm-opening (32-mesh) sieve in such rice modifier according to Japanese Industrial Standard (JIS) is not smaller than 5% by weight and not larger than 100% by weight, preferably not smaller than 10% by weight and not larger than 100% by weight, and more preferably not smaller than 30% by weight and not larger than 100% by weight. The content of the particles over 0.5 mm-opening (32-mesh) sieve is controlled within the above-described range to provide improved dispersibility over the cooking rice. Excessively lower content of the particles over 0.5 mm-opening (32-mesh) sieve causes a precipitation of starch that serves as a modifier, and the precipitated starch is first gelatinized to increase viscosity of the cooking water, disturbing uniform cooking.

The rice modifier of the present invention provides improved gloss and stickiness of the rice for cook during the cooking process by thermally hydrating and dispersing the starch serving as the modifying constituent uniformly in the rice for cook. In order to attain such purpose, a property of quickly dissolving during the cooking is critical. In the present invention, “thermal solubility” is employed as an indicator for indicating such property. A method for measuring the thermal solubility is as follows.

1. 500 mg of a sample by dry weight is weighed to place into a glass test tube having a diameter of 18 mm and a length of 180 mm. At this time, the precise weight of the weighed sample (weight before heating) is recorded.

2. 10 milliliter (mL) of distilled water is added to the above-described 1 and then is stirred to disperse it well.

3. An aluminum cap is disposed thereon and is heated with a boiling bath for 20 minutes. In such case, the sample is sometimes dispersed well so as to avoid unmixed-in lump of the sample.

4. After the heating is finished, it is cooled in flowing water.

5. The content of the test tube is transferred to a centrifugation tube of 50 mL with a cap. In such case, the weight of the empty centrifugation tube (without cap) is measured. The adhered content onto the wall of the test tube is washed by adding distilled water, and the washing water is also poured into the centrifugation tube to adjust the total quantity to 30 mL.

6. A centrifugal separation is conducted (3000 rpm, 10 minutes), and then supernatant liquid is carefully removed.

7. The sample is dried within a thermostatic chamber at 100 degrees centigrade for around twenty-four hours, and then the weight after the drying (weight of the empty centrifugation tube+weight of the rice modifier remained in the centrifugation tube) is measured.

8. The thermal solubility is calculated by the following formula.

Thermal solubility(%)=100−[(weight after the drying−weight of the empty centrifugation tube)/weight before heating)]×100.

9. The thermal solubility is measured for three times for each sample, and the thermal solubility is determined as the average thereof.

The thermal solubility of the rice modifier in the present invention is equal to or higher than 20%, and preferably equal to or higher than 50%. Having this configuration, the modifier is sufficiently dispersed in the cooking process, obtaining considerable level of the modifying effect for the cooked rice. While the upper limit of the thermal solubility is not particularly limited, the thermal solubility of, for example, up to 90% would provide sufficient modifying effect.

The starch content in the rice modifier according to the present invention is not smaller than 40% by weight and not larger than 100% by weight, and preferably not smaller than 50% by weight and not larger than 100% by weight. Having such starch content achieves better gloss, stickiness and eating-quality.

Subsequently, the constituents constituting the rice modifier according to the present invention will be described in detail.

Starch employed in the present invention includes corn starch, waxy corn starch, potato starch, waxy potato starch, wheat starch, rice starch, glutinous rice starch, sweet potato starch, tapioca starch, Mung Bean starch, sago starch or pea starch.

Here, according to the investigation of the present inventors, it is clarified that the above-described starches can be generally classified into: (A) starches having a function for providing improved eating-quality and flavor; and (B) starches that provides improving thermal solubility. The rice modifier according to the present invention preferably includes both properties of the above-described (A) and (B). This allows providing improved dispersibility of the rice modifier in the cooked rice, and considerably enhanced effect of improving eating-quality.

Typical starch of the above-described (A) includes starch containing amylose at a content of equal to or smaller than 20%. The amylose content is equal to or smaller than 20% would provide considerably enhanced effect of improving eating-quality.

The starch containing amylose at a content of equal to or smaller than 20% typically includes waxy starches such as waxy corn starch, glutinous rice starch and the like, potato starch, tapioca starch and the like. The type of the starch obtained by processing the above-described starches as raw materials for providing the ageing resistance, or in other words starches with esterification processing (with, for example, starch acetate, starch octenyl succinate and the like) or etherified processing (with for example, hydroxypropyl starch and the like) may be employed. In addition, these ageing resistance starches may be employed in combination with cross-link processing (for example, phosphoric acid-cross linking starch). These starches may be utilized alone or in combination with two or more thereof.

In the present invention, content of the starch containing amylose at a content of equal to or smaller than 20% is preferably equal to or larger than 25% by weight, and more preferably equal to or larger than 40% by weight. This allows providing considerably enhanced effect of improving eating-quality and flavor. While the upper limit of the content is not particularly limited, the upper limit may be preferably equal to or smaller than 95% by weight, and more preferably equal to or smaller than 80% by weight, in view of ensuring sufficient amount of the above-described (B) to provide improved thermal solubility.

As the starches included in the above-described (B), the starch exhibiting solubility by heating and also exhibiting smaller increase in the viscosity is preferably employed. Adding such type of starch achieves uniform dispersion of the modifier without increasing the viscosity of the cooking water during the cooking process, providing improved effect for modifying the rice. Such types of starch typically include acid-treated starch, oxidized starch, dextrin and the like. Among these, in view of reducing an influence over the eating-quality and preventing a yellowing of the cooked rice over time after cooking, acid-treated starch and oxidized starch are preferably employed.

The rice modifier according to the present invention preferably contains acid-treated starch or oxidized starch, and the content is preferably equal to or larger than 5% by weight, and more preferably equal to or larger than 10% by weight Having this configuration, better thermal solubility is achieved. While the upper limit of the content is not particularly limited, the upper limit may be preferably equal to or smaller than 75% by weight, and more preferably equal to or smaller than 60% by weight, in view of ensuring sufficient amount of the above-described (A) to provide improved eating-quality.

The rice modifier according to the present invention may contain various types of additives other than starches.

For example, the rice modifier according to the present invention may contain saccharide. Having such configuration, aging of the starch serving as the modifier is reduced, maintaining appropriate gloss and stickiness. Saccharides employed in the present invention is not particularly limited to any specific saccharide provided that the saccharide is presented in the foods, and glucose, sucrose, fructose, maltose, lactose, trehalose, or sugar alcohols such as xylitol, sorbitol, maltitol, erythritol and the like, or invert sugar of saccharide. Further, materials containing reducing sugar, starch syrup mixture, powder starch syrup, and the like, which contains the above-described saccharides as a constituent, may be similarly employed. These saccharides may be employed alone, or in a form of a combination of two or more thereof, and preferably, trehalose alone, or a combination of trehalose and the above-described saccharides, may be employed. Adding quantity of these saccharides over the rice modifier is preferably 0.1 to 60 parts by weight over 100 parts by weight of the rice modifier, and more preferably 10 to 50 parts by weight.

The rice modifier according to the present invention may include fat or oil. Addition of a fat or oil in the modifier provides improved release-ability of the cooked rice from a rice kettle, improving workability. The fat and oil employed in the present invention is not particularly limited to any specific material provided that it is presented in an ordinary food, and typically include plant oils such as linseed oil, tung oil, safflower oil, Japanese torreya nuts oil, walnut oil, poppy seed oil, sunflower oil, cotton seed oil, rapeseed oil, soya bean oil, mustard oil, kapok oil, rice bran oil, sesame oil, corn oil, peanut oil, olive oil, camellia oil, tea oil, castor oil, coconut oil, palm oil and the like, and animal fats and oils such as beef fats, fish oils, whale oils, lard, sheep oils and the like. In addition, materials obtained by conducting transesterification of the above-described oils and fats, hardened oils, fractionated oils, and additionally fats or oils obtained by a chemical process or an enzyme process such as MCT (medium chain triglycerides), diglycerides and the like, may also be employed. In addition, so-called “cooking-dedicated oils”, which are oils added to an emulsifying agent and the like for providing enhanced dispersion during the cooking, may also be employed. Adding quantity of these oils and fats over the rice modifier is preferably 0.1 to 10 parts by weight over 100 parts by weight of the rice modifier, and more preferably 0.1 to 5 parts by weight.

In the present invention, emulsifying agents such as sucrose fatty acid ester, fatty acid ester and the like, crystalline cellulose, enzymatic hydrolysis dextrin, indigestible dextrin, cluster dextrin, cyclodextrin, maltooligosaccharide, isomaltooligosaccharide, galacto oligosaccharide and the like, which are generally employed as vehicles or diluting agents, may also be employed as required.

Further, higher dispersibility of the rice modifier of the present invention may be utilized to contain nutrition functional constituents such as minerals such as calcium, iron and the like, vitamin groups, dietary fibers and the like, kneaded therein, so that a cooked rice having nutrition-supplement function may be easily prepared.

The geometry of the rice modifier of the present invention is not particularly limited, provided that the geometry provides easier addition in the rice and faster dissolution during the cooking process. Various types of geometries such as spherical geometry, cylindrical geometry, rice grain-like geometry and the like may be obtained by employing different geometries of a discharge opening (die) of a granulator.

In order to enhance the effects of the rice modifier of the present invention, preferable bulk specific gravity of the modifier is 0.5 or higher. Having such configuration, the dispersibility of the rice modifier in the cooking process is further improved. For example, when the cooking is conducted in a industrial cooking line, better dispersibility is expected to be obtained before cooking without stirring and mixing the rice and the rice modifier, in view of the process efficiency. Preferably 0.5 or higher of the bulk specific gravity, and more preferably 0.55 or higher, stably achieves the above-described better dispersibility.

In addition, the rice modifier of the present invention may contain the starch containing amylose at a content of equal to or smaller than 20% at equal to or larger than 25% by weight, and the bulk specific gravity of the modifier may be equal to or higher than 0.5. This can provide further improved balance of the dispersing stability and the eating-quality of the modifier.

Here, the method of measuring the bulk specific gravity may be conducted as follows.

1. About 100 g of a sample (particles over 0.5 mm-opening (32-mesh) sieve is employed) is weighed in a test scoop.

2. Empty weight of a test cup of 100 mL is measured.

3. The test cup is disposed in a vat, and the weighed sample is calmly fed.

4. The protruded portion of the sample over the upper surface of the test cup is calmly cut by hand, and then the total weight of the test cup and the sample is measured, and the bulk specific gravity is calculated by the following formula:

Bulk specific gravity=(total weight of test cup and sample−empty weight of test cup)/100.

The process for preparing the rice modifier of the present invention includes, for example, an operation for granulating a raw material containing starch of 40% by weight or larger so as to have thermal solubility of equal to or larger than 20% and have a content of the granular particles over 0.5 mm-opening (32-mesh) sieve of not smaller than 5% by weight and not larger than 100% by weight. The apparatus employed in the preparation of the rice modifier of the present invention is not particularly limited to any specific apparatus, and generally employed granulator apparatus such as vibrating, tumbling, stir-mixing, fluidizing, cracking granulators represented by pan granulators, compression molding, wet or dry extruding granulators and the like, may be employed. Among these, in view of preparation efficiency and adhesiveness of the grains, extruding granulators utilizing a twin-screw extruder may be preferably employed. When an extruder is employed for the processing, water is generally added to a raw material containing starch and saccharide, or fat and oil and the water content is adjusted to 10 to 50% by weight, and then an extruding granulation is conducted under the conditions at a temperature of 20 to 200 degrees centigrade, in a screw rotation of 100 to 1000 rpm, and a time for thermal processing of 5 to 60 seconds to obtain the rice modifier.

The rice modifier of the present invention may be employed to be previously mixed to rice or wash-free rice (“musennmai”), or to be added in the cooking process. When it is added in the cooking process, it may added before the rice is immersed in water or may be added to the immersed rice, and in both cases, the rice may preferably be lightly stirred after adding the modifier, in order to uniformly disperse the modifying constituent of the rice modifier. Adding quantity of the rice modifier over the whole rice for cook is preferably not smaller than 0.1% by weight and not larger than 10% by weight, and more preferably not smaller than 1% by weight and not larger than 10% by weight. An excessively lower adding quantity may cause insufficient modifying effect to cooked rice. On the contrary, an excessively higher adding quantity may cause excessively higher stickiness of the cooked rice, increasing adhesion to the rice kettle or the successive production lines, thereby deteriorating the workability.

The cooked rice food according to the present invention is a cooked rice with adding the rice modifier at a content of not smaller than 0.1% by weight and not larger than 10% by weight over the rice. This allows maintaining and improving gloss and stickiness of the cooked rice, which are otherwise deteriorated during the preservation at an ambient temperature after the cooking or in the distribution. Therefore, the modifier can be utilized to variety of cooked rice foods such as cooked rice for lunch boxes, rice balls, cooked rice foods including various foods (“takikomi-gohan”), fried rice, paella, rizotto and the like, which are exhibited in convenience stores and superstores. Further, utilizations in the types of cooked rice foods that require chilled distribution, typically as sushi or rice balls, are expected. On the other hand, when the modifier is employed in the types of the cooked rice foods such as foods employing miscellaneous grain crops such as five grains rice, which tend to be dried out after the cooking, stickiness thereof can be maintained for longer time. Further, when the rice modifier of the present invention is employed for old rice or low-grade rice, old rice-smell, or rice bran smell can be reduced, changing these types of rice as the cooked rice foods having eating-quality, eating-texture and flavor that new rice or upper grade rice originally have.

As described above, the rice modifier in the present invention is uniformly distributed over the cooking rice and is gradually dissolved during the cooking process, and this allows providing gloss and stickiness uniformly over the cooked rice. Similar materials obtained by processing starch into granular material and employed as adding to the rice during the cooking process include starch rice, which is employed as a low protein food, and technological developments of which were flourishingly progressed as a rice-alternative food in the occasion of food shortage after the war. The starch rice, similarly as the product of the present invention, is a food, which was developed in order to reproduce the eating-texture similar to that of the eating-quality of the rice, produced by processing starch such as corn starch into granular form and boiling thereof. The difference of such starch rice from the rice modifier according to the present invention is that the modifier is requested to be designed that starch serving as the modifying constituent is dissolved during the cooking process to uniformly disperse in the cooked rice in order to maximize exhibiting the function of the rice modifier, without existing the modifier as a granular form in the cooked rice. On the contrary, the starch rice cannot contribute its advantageous effects, without maintaining appropriate eating-texture and form like the rice has, by absorbing water during the cooking process to be gelatinized. As the results of exhibiting their own functions in the end of the cooking, the modifier must be dissolved, and on the contrary the starch rice must maintain their form.

### EXAMPLES

Examples of the present invention will be shown in the following, and it is not intended to limit the scope and the spirit of the present invention thereto. In addition to above, in the examples, “AP-Y” was employed for waxy corn starch; “A-09” for etherified waxy corn starch; “A-800” for esterification tapioca starch; “R-100” for acid-treated starch; “FZ-100” for dextrin; and “BP-200” for potato starch, all of which are commercially available from J-OIL MILLS, Inc. “Sun-deck” commercially available from Sanwa Cornstarch Co., Ltd. was employed for the powder starch syrup; trehalose manufactured by Hayashibara Co., Ltd., was employed; “Actor M-107FR” commercially available from Riken Vitamin Co., Ltd., was employed for the edible oil and fat; wheat germ manufactured by Nippon Flour Mills Co., Ltd., was employed; and mixed enzyme containing papain and diastase at a ratio of 1:1 (both commercially available from Seikagaku Kogyo Co., Ltd.) was employed.

Further, the thermal solubility was measured by the above-mentioned method, and was obtained by averaging three thermal solubilities for each sample.

### 1. Evaluation of Dispersibility During the Cooking Process

Materials were mixed according to the formulations 1 to 3 in Table 1, and a twin-screw extruder (“KEI-45”, commercially available from Kowa Kogyo Co., Ltd.) was employed to conduct an extruding processing under the conditions of a barrel temperature of 100 degrees centigrade, an outlet temperature of 60 degrees centigrade, hydration of 33%, and a screw rotation of 200 rpm.

For the formulation 1, another sample of the same formulation but different bulk specific gravity was also produced. More specifically, another sample of the modifier of the formulation 1 prepared by another extruding processing under the conditions of a barrel temperature of 130 degrees centigrade, an outlet temperature of 120 degrees centigrade, hydration of 15%, and a screw rotation of 200 rpm, was also prepared.

The extruder-treated granulated substance was dried to water content of 10%, and then was sieved, and the fraction through the 10 mm-opening sieve and staying over 0.5 mm-opening (32-mesh-) sieve was employed as the rice modifier.

Here, in the formulation 1 to 3, waxy corn starch was employed for starch containing amylose at a content of equal to or smaller than 20%. Waxy corn starch contains substantially no amylose, and contains amylopectin at a rate of roughly 100%.

10 g of the rice modifier was first added to a rice kettle, and subsequently 190 g of rice was added, and then 260 mL of water was added without mixing thereof, and then cooked after staying thereof to cause an immersion for one hour. The obtained cooked food was transferred into a vat from the rice cooker without mixing, and then dispersibility of the modifying constituent was evaluated by a visual inspection. Double circle was assigned when the modifier is uniformly dispersed and there was not sense of incongruity in the cooked rice at all as compared with a control example; Single circle (o) was assigned when there was hardly sense of incongruity; Triangle (Δ) was assigned when part of the modifier was not dissolved in the rice and there was some sense of incongruity; and Cross (x) was assigned when the modifier was localized and there was a sense of incongruity, and the results were shown in Table 2.

Table 2 show results of the following Examples: Examples 1 and 2 were for modifiers of the formulations 1 and 2 in Table 1; Example 3 was for the formulation of the formulation 1 and providing lower bulk specific gravity; Comparative Example 1 was for a modifier of formulation 3; Comparative Example 2 was for the formulation 1 without a granulation by an extruder and added to the cooked rice in a form of powder; and Control Example was for the cooked rice of 200 g of rice and 260 mL of water without adding modifier.

TABLE 1

| | FORMULATION 1 | FORMULATION 2 | FORMULATION 3 |
|---|---|---|---|
| WAXY CORN STARCH | 45 | 80 | 98 |
| ACID-TREATED STARCH | 30 | 10 | 1 |
| TREHALOSE | 25 | 10 | 1 |
| STARCH CONTENT (% BY WEIGHT) | 75 | 90 | 99 |
| CONTENT OF THE STARCH CONTAINING AMYLOSE AT A | 45 | 80 | 98 |
| CONTENT OF EQUAL TO OR SMALLER THAN 20% (% BY WEIGHT) | | | |
| THERMAL SOLUBILITY (%) | 66 | 37 | 15 |

TABLE 2

| | | | | COMPARATIVE | COMPARATIVE | |
|---|---|---|---|---|---|---|
| | EXAMPLE 1 | EXAMPLE 2 | EXAMPLE 3 | EXAMPLE 1 | EXAMPLE 2 | CONTROL |
| | FORMULATION | FORMULATION | FORMULATION | FORMULATION | FORMULATION | EXAMPLE |
| | 1 | 2 | 1 | 3 | 1 | — |
| BULK SPECIFIC | 0.6 | 0.6 | 0.4 | 0.6 | — | — |
| GRAVITY | | | | | | |
| DISPERSIBILITY | ⊚ | ◯ | ◯ | X | X | — |
| FRACTION OVER | 100 | 100 | 100 | 100 | 0 | — |
| 0.5 mm-OPENING | | | | | | |
| (32-MESH) | | | | | | |
| COMMENT | GOOD | GOOD | GLUE LAYERS | STARCH | A LOT OF | |
| | DISPERSIBILITY | DISPERSIBILITY | WERE | GRAINS | OBLATE- | |
| | NO INCONGRUITY | LITTLE | OBSERVED | WERE DOTTED | LIKE LAYERS | |
| | | INCONGRUITY | IN UPPER | WITHIN | WERE OBSERVED | |
| | | | PORTION OF | COOKED RICE | IN BOTTOM OF | |
| | | | COOKED RICE | | RICE COOKER | |

The modifier having lower thermal solubility as the Comparative Example 1 was remained in the cooked rice after the cooking without completely dissolved, and exhibited considerably inferior dispersibility. Further, in the Comparative Example 2 of the adding in the form of power without a granulation with an extruder, a glue layer of the starch was adhered around the bottom of the rice kettle, and the cooked rice was harder, and thus it was concluded that uniform cooking was not achieved. In addition, in Example 3 for lower bulk specific gravity, since rice modifiers was partially floated before the cooking process, glue layers were partially observed on the surface of the rice food after the cooking. On the other hand, Example 1 having higher thermal solubility was observed to be completely dissolved, and was uniformly dispersed without adhering the glue layer to the bottom.

### 2. Evaluation of Influence by Starch Type and Content

Rice food modifiers were prepared according to the formulations in Table 3, similarly as in Example 1. As the starch containing amylose at a content of equal to or smaller than 20%, etherified waxy corn starch and esterified tapioca starch were employed for the formulations 4 and 5, respectively, and waxy corn starch was employed for the formulations 6 to 8 and 10. A material equivalent to the “product name D” disclosed in Patent Document 5 was employed for the formulation 9. Similarly as the rice modifiers of the formulations in Table 1, the rice was cooked in the rice kettle, and the dispersibility of the cooked rice was evaluated by a visual inspection. The cooked rice obtained was cooled with a vacuum cooler, and the eating-qualities just after the cooling and 24 hours after the cooking were evaluated using “SATAKE cooking eating-quality indicator STA1A”. Further, sensory evaluations of obtained cooked food 24 hours after the cooking were conducted by 10 panelist persons. The evaluation items of color and gloss, eating-quality, stickiness and flavor (rice bran smell) were employed, and relative evaluations were conducted as compared with Control Example without adding the modifier.

Double circle: Distinctly preferable as compared with Control Example;
Single circle (o): Preferable as compared with Control Example;

### Triangle (Δ): Equivalent to Control Example; and

### Cross (x): Inferior to Control Example.

The results are shown in Tables 4-1 and 4-2.

TABLE 3

| | FORMULATION | FORMULATION | FORMULATION | FORMULATION |
|---|---|---|---|---|
| | 4 | 5 | 6 | 7 |
| WAXY CORN STARCH | | | 45 | 20 |
| ETHERIFIED WAXY CORN STARCH | 45 | | | |
| ESTERIFIED TAPIOCA STARCH | | 45 | | |
| POTATO STARCH | | | | |
| ACID-TREATED STARCH | 30 | 30 | 30 | 30 |
| TREHALOSE | 25 | 25 | 20 | 50 |
| DEXTRIN | | | | |
| POWDER STARCH SYRUP | | | | |
| WHEAT GERM | | | | |
| EDIBLE OIL | | | 5 | |
| ENZYME | | | | |
| STARCH CONTENT | 75 | 75 | 75 | 50 |
| (% BY WEIGHT) | | | | |
| CONTENT OF THE STARCH | 45 | 45 | 45 | 20 |
| CONTAINING AMYLOSE AT A | | | | |
| CONTENT OF EQUAL TO OR | | | | |
| SMALLER THAN 20% | | | | |
| (% BY WEIGHT) | | | | |
| THERMAL SOLUBILITY (%) | 63 | 77 | 80 | 85 |

| | FORMULATION | FORMULATION | FORMULATION |
|---|---|---|---|
| | 8 | 9 | 10 |
| WAXY CORN STARCH | 10 | | 60 |
| ETHERIFIE WAXY CORN STARCH | | | |
| ESTERIFIED TAPIOCA STARCH | | | |
| POTATO STARCH | | 35 | |
| ACID-TREATED STARCH | | | 35 |
| TREHALOSE | | | |
| DEXTRIN | 90 | | |
| POWDER STARCH SYRUP | | 60 | |
| WHEAT GERM | | 4.8 | |
| EDIBLE OIL | | | 5 |
| ENZYME | | 0.2 | |
| STARCH CONTENT | 10 | 35 | 95 |
| (% BY WEIGHT) | | | |
| CONTENT OF THE STARCH | 10 | 35 | 60 |
| CONTAINING AMYLOSE AT A | | | |
| CONTENT OF EQUAL TO OR | | | |
| SMALLER THAN 20% | | | |
| (% BY WEIGHT) | | | |
| THERMAL SOLUBILITY (%) | 91 | 65 | 84 |

TABLE 4-1

| | | EXAMPLE 4 | EXAMPLE 5 | EXAMPLE 6 | EXAMPLE 7 |
|---|---|---|---|---|---|
| | | FORMULATION | FORMULATION | FORMULATION | FORMULATION |
| | | 1 | 2 | 4 | 5 |
| DISPERSIBILITY | | ⊚ | ◯ | ⊚ | ⊚ |
| AFTER | APPEARANCE | 89 | 89 | 91 | 91 |
| COOKING | STICKINESS | 88 | 88 | 91 | 89 |
| | EATING-QUALITY | 86.0 | 86.3 | 87.3 | 87.0 |
| | VALUE | | | | |
| AFTER | APPEARANCE | 81 | 76 | 84 | 83 |
| 24 HOURS | STICKINESS | 80 | 72 | 85 | 80 |
| | EATING-QUALITY | 79.7 | 76.0 | 82.0 | 81.0 |
| | VALUE | | | | |

| | | | | |
|---|---|---|---|---|
| SENSORY EVALUATION, | ⊚ | ◯ | ⊚ | ⊚ |
| COLOR AND GLOSS | | | | |
| STICKINESS | ◯ | ◯ | ⊚ | ⊚ |
| EATING-QUALITY | ⊚ | ◯ | ⊚ | ◯ |
| FLAVOR (RICE BRAN SMELL) | ⊚ | ⊚ | ⊚ | ◯ |

| | | EXAMPLE 8 | EXAMPLE 9 | EXAMPLE 10 |
|---|---|---|---|---|
| | | FORMULATION | FORMULATION | FORMULATION |
| | | 6 | 7 | 10 |
| DISPERSIBILITY | | ⊚ | ◯ | ◯ |
| AFTER | APPEARANCE | 92 | 87 | 91 |
| COOKING | STICKINESS | 88 | 84 | 90 |
| | EATING-QUALITY | 87.3 | 84.7 | 85.7 |
| | VALUE | | | |
| AFTER | APPEARANCE | 80 | 72 | 80 |
| 24 HOURS | STICKINESS | 75 | 68 | 79 |
| | EATING-QUALITY | 78.7 | 73.7 | 79.0 |
| | VALUE | | | |

| | | | |
|---|---|---|---|
| SENSORY EVALUATION, | ◯ | ◯ | ⊚ |
| COLOR AND GLOSS | | | |
| STICKINESS | ⊚ | ◯ | ◯ |
| EATING-QUALITY | ⊚ | ◯ | ◯ |
| FLAVOR (RICE BRAN SMELL) | ⊚ | ◯ | ⊚ |

TABLE 4-2

| | | COMPARATIVE EXAMPLE 3 | COMPARATIVE EXAMPLE 4 | CONTROL EXAMPLE |
|---|---|---|---|---|
| | | FORMULATION 8 | FORMULATION 9 | — |
| DISPERSIBILITY | | ⊚ | Δ | — |
| AFTER | APPEARANCE | 84 | 84 | 84 |
| COOKING | STICKINESS | 78 | 75 | 79 |
| | EATING-QUALITY | 80.7 | 86.0 | 81.0 |
| | VALUE | | | |
| AFTER 24 | APPEARANCE | 64 | 68 | 65 |
| HOURS | STICKINESS | 60 | 56 | 61 |
| | EATING-QUALITY | 66.0 | 70.0 | 69.3 |
| | VALUE | | | |

| | | | |
|---|---|---|---|
| SENSORY EVALUATION, | Δ | X | — |
| COLOR AND GLOSS | | | |
| STICKINESS | X | X | — |
| EATING-QUALITY | Δ | X | — |
| FLAVOR (RICE BRAN SMELL) | ◯ | Δ | — |

As shown in Examples 6 and 7 of Table 4-1, the modifying effect was maintained, even if the starch content was changed from waxy corn starch to etherified waxy corn starch and esterified tapioca starch. As shown in Examples 8 and 10, fat or oil was added to the formulation to provide reduced adhesion of the cooked rice to the rice kettle, providing the products that exhibit enhanced usability. Even in the case where the thermal solubility is slightly lower as in Example 5 or in the case where the content of the starch containing amylose at a content of equal to or smaller than 20% is lower as in Example 9, the modifying effect was significantly confirmed as compared with Control Example, though the modifying effect is slightly reduced. In the case where the formulation level of the starch containing amylose at a content of equal to or smaller than 20% was extremely lower as in Comparative Example 3, or in the case where the starch content is lower as in Comparative Example 4, no modifying effect after 24 hours was not particularly found.

### 3. Evaluation in the Influence of the Particle Size

Another modifier was separately prepared, which was obtained by pulverizing the modifier granules of formulation 1, which had been granulated in the process of Example 1, with a pulverizer under 0.5 mm-opening (32-mesh), and the modifier without the pulverization (over 0.5 mm-opening (32-mesh)) and the modifier with the pulverization (under 0.5 mm-opening (32-mesh)) were mixed according to formulations of Table 5 to prepare the rice modifiers. These rice modifiers were added at a content of 5% similarly as in Example 1, and then were cooked. The cooked rice obtained was transferred into a vat from the rice cooker without stirring, being mixed, and the dispersibility of the modifying constituent was evaluated by a visual inspection. Thereafter, the obtained rice food was cooled with a vacuum cooler, and the eating-qualities just after the cooling and 24 hours after the cooking were evaluated using “SATAKE cooking eating-quality indicator STA1A”, and the results are shown in Table 5.

TABLE 5

| | | EXAMPLE 10 | EXAMPLE 11 | COMPARATIVE EXAMPLE 5 |
|---|---|---|---|---|
| OVER 10 mm-OPENING (% BY WEIGHT) | | 0 | 0 | 0 |
| OVER 0.5 mm-OPENING (32-MESH) | | 80 | 10 | 0 |
| (% BY WEIGHT) | | | | |
| UNDER 0.5 mm-OPENING (32-MESH) | | 20 | 90 | 100 |
| (% BY WEIGHT) | | | | |
| DISPERSIBILITY | | ⊚ | ◯ | X |
| COMMENT | | GOOD | SOME OBLATE-LIKE LAYERS | A LOT OF OBLATE-LIKE LAYERS |
| | | DISPERSIBILITY | WERE OBSERVED IN BOTTOM | WERE OBSERVED IN |
| | | NO INCONGRUITY | OF KETTLE, NO OBSTRUCTION | BOTTOM OF RICE COOKER |
| | | | FOR WORKING | |
| AFTER | APPEARANCE | 88 | 85 | 80 |
| COOKING | STICKINESS | 93 | 90 | 81 |
| | EATING-QUALITY VALUE | 87.0 | 85.0 | 82.0 |
| AFTER | APPEARANCE | 72 | 72 | 66 |
| 24 HOURS | STICKINESS | 70 | 70 | 58 |
| | EATING-QUALITY VALUE | 74.3 | 73.0 | 67.0 |

As shown in Table 5, the cooking modifier containing higher fraction over the 0.5 mm-opening (32-mesh) exhibited higher dispersibility of modifying constituent for the cooked rice, resulting preferable evaluation of the cooked rice 24 hours after the cooking.

As described above, according to the formulation described in Examples, the cooked rice modifying constituent is uniformly dispersed in the occasion of the cooking process, and a quality loss in the preservation of the cooked rice is not caused. In addition to above, when such rice modifier is employed for old rice or low-grade rice, old rice-smell, or rice bran smell can be reduced, changing these types of rice as the cooked rice food having eating-quality, eating-texture and flavor that new rice or upper grade rice originally have.

1. A rice modifier, containing a granular material sieved over 0.5 mm-opening (32-mesh) sieve at a content of 5% by weight or more and 100% by weight or less, having thermal solubility of equal to or higher than 20%, and containing a starch at a content of equal to or larger than 40% by weight.

2. The rice modifier as set forth in claim 1, wherein the modifier contains a starch containing amylose at a content of equal to or smaller than 20% at a content of equal to or larger than 25% by weight.

3. The rice modifier as set forth in claim 2, wherein the modifier contains the starch containing amylose at a content of equal to or smaller than 20% at a content of 25% by weight or more and 95% by weight or less, and also contains acid-treated starch or oxidized starch at a content of 5% by weight or more and 75% by weight or less.

4. The rice modifier as set forth in claim 3, wherein
said thermal solubility is equal to or higher than 50%.

5. The rice modifier as set forth in claim 4, wherein
bulk specific gravity is equal to or higher than 0.5.

6. The rice modifier as set forth in claim 2, wherein bulk specific gravity is equal to or higher than 0.5.

7. A process for preparing of a rice modifier, including:
granulating a raw material containing a starch at a content of equal to or larger than 40% by weight to create a granular material having thermal solubility of equal to or higher than 20% and having a size distribution, in which particles sieved on 0.5 mm opening (32-mesh) sieve are included at a content of 5% by weight or more and 100% by weight or less.

8. A process for preparing a cooked rice food, including:
cooking a rice after adding the rice modifier as set forth in claim 1 at a ratio of 0.1% by weight or more and 10% by weight or less over the rice.

9. A cooked rice food cooked by the process as set forth in claim 8.
